(19) United States
(12) Patent Application Publication
(10) Pub. No.: US 2014/0067556 A1
(43) Pub. Date: Mar. 6, 2014

(54) METHODS AND SYSTEMS FOR ESTABLISHING A MOBILE-OPTIMIZED WEB PRESENCE AND A MOBILE-OPTIMIZED MARKETING CAMPAIGN

(71) Applicants: Sharon Burt, North Kingstown, RI (US); Jeffrey Collemer, Cumberland, RI (US); Carl Dunham, Wakefield, RI (US); Jason Stedman, Westerly, RI (US); Jeffrey Theroux, Cumberland, RI (US)

(72) Inventors: Sharon Burt, North Kingstown, RI (US); Jeffrey Collemer, Cumberland, RI (US); Carl Dunham, Wakefield, RI (US); Jason Stedman, Westerly, RI (US); Jeffrey Theroux, Cumberland, RI (US)

(21) Appl. No.: 13/599,630

(22) Filed: Aug. 30, 2012

(51) Int. Cl. G06Q 30/02

(52) U.S. Cl. CPC G06Q 30/0277
USPC 705/14.73

(57) ABSTRACT

Methods and systems for establishing a web presence, a mobile-optimized web presence, a marketing campaign and a mobile-optimized marketing campaign. Various embodiments of the methods and systems disclosed herein may permit independently generating mobile-optimized and desktop versions of one or more web presences, landing pages and marketing campaigns based on business information. Computer systems implementing methods of establishing mobile-optimized web presences and marketing campaigns are also disclosed.

### BACKGROUND

1. Field of the Disclosure

Aspects of the present disclosure relate to online advertising.

2. Description of Background

Small businesses face a variety of challenges with regard to marketing their products or services via the internet. There are many online marketing channels and approaches available, but many are rather complex to master and require a degree of expertise that small businesses often do not possess. Large businesses, by contrast, may maintain multiple staff members in order to ensure effective and comprehensive coverage of the online marketing space, and sometimes even employ the services of an external online marketing firm, such as an advertisement or a search agency, to augment their internal capabilities.

A major challenge for small businesses is the proliferation of web presences and marketing channels. A web presence conventionally refers to merely a company's website which represents the company to customers from a communications and marketing standpoint. However, in addition to a website, a web presence may currently encompass numerous other venues available to a company for representation, marketing and advertising to customers. For example, businesses may establish a web presence in the form of a Facebook page, a Twitter profile, a Foursquare check-in profile, a YouTube Channel, and the like.

A wide variety of web marketing solution providers may be available to small businesses. However, small businesses are often faced with a challenge of utilizing one provider for one aspect of their marketing and another provider for other aspects. For example, a small business owner may engage a local website designer to create a website, but the website designer may not have expertise in designing and executing paid search campaigns, or in buying demographically targeted ads via Facebook.

A few providers have attempted to address the complexities facing small business owners by providing end-to-end internet marketing services. Online-focused services such as ReachLocal, Clickable, and Yodle typically charge a monthly fee, and sometimes a setup fee, to create a website for clients and to spend the client's marketing budget on a variety of internet marketing channels, most notably paid search via the search engines. Other providers such as traditional Yellow Pages vendors have begun providing similar services, both as standalone offerings focused on online services and also as offerings bundled with their offline Yellow Pages advertising services. This allows the Yellow Pages vendors to leverage their geographically distributed local sales forces to sell multiple services, and allows their small business customers to obtain multiple services from one vendor.

The increasing proliferation of mobile browsers is an additional challenge for small businesses. According to a Nielsen survey, released Feb. 20, 2012, out of 20,000 mobile consumers surveyed, 48% of them had smartphones, i.e. cell phones with a web browser. According to another survey, by the Pew Research Center's Internet & American Life Project, more than half of adult cell phone owners used their cell phones while they were in a store during the 2011 holiday season to seek help with purchasing decisions.

### SUMMARY OF INVENTION

While end-to-end internet marketing services provided by web marketing solution providers are emerging, these solution providers rely on conventional approaches to creating websites. For example, creation and setup of websites and marketing campaigns may rely on individuals designing and creating websites without any automation. In other examples, solution providers may leverage varying levels of automation to setup a desktop version of a website or otherwise to setup a desktop version of a marketing campaign, without specifically addressing the need to market to mobile users.

The proliferation of web presences and marketing channels, and the additional challenge of marketing to mobile users and satisfying the unique requirements of users who access information via a plethora of differing mobile devices make the field of online marketing a daunting and complex one for small businesses.

According to aspects of the present invention, it is appreciated that establishing and maintaining web presences and marketing campaigns and mobile-optimized versions thereof where potential customers can access information about products and services via one or more types of devices, may be a daunting task for businesses, and particularly for small businesses with limited resources.

Mobile web browsers present a challenge when creating web sites and marketing campaigns because, for example, the screen formats are different than desktop browser screen formats. In some instances, screen formats of mobile browsers may be smaller and more limited. Mobile marketing campaigns, such as paid search campaigns, may involve different screen and ad formats. Additionally, detecting and displaying content properly formatted for mobile browsers is difficult because of the proliferation of different devices and browsers. Conventional approaches to creating mobile websites include doing so manually and may also include “screen scraping,” or automatically scanning a desktop-optimized website to convert it to a separate mobile website. However, conventional approaches may be inefficient and may rely on conversion from desktop-optimized versions.

Aspects and embodiments disclosed herein are directed to providing methods and systems for establishing both desktop and mobile-optimized web presences and marketing campaigns. Various embodiments of the present invention address the challenges described above and enable generation of web presences and marketing campaigns and mobile-optimized web presences and mobile-optimized marketing campaigns. Some embodiments may be implemented on a computer system and may provide a convenient user interface, such as a user interface for entering business information. In some embodiments, the business information may be used by a solution provider for automatically establishing desktop-optimized web presences and marketing campaigns and for simultaneously establishing mobile-optimized web presences and marketing campaigns.

According to one aspect, there is provided a computer-based method for generating a web presence. The method comprises acts of accessing, over a computer network, business information; generating at least one web presence based on the business information; generating at least one mobile-optimized web presence based on the business information, the at least one mobile-optimized web presence being generated independently from the at least one web presence; generating at least one landing page based on the business information; generating at least one mobile-optimized landing page based on the business information, the at least one mobile-optimized landing page being generated independently from the at least one landing page; generating at least one marketing campaign based on the business information; generating at least one mobile-optimized marketing campaign based on the business information; associating the at least one marketing campaign with the at least one web presence and the at least one landing page; and associating the at least one mobile-optimized marketing campaign with the mobile-optimized web presence and the at least one mobile-optimized landing page.

In one embodiment, the method may further comprise an act of activating the at least one web presence, the at least one mobile-optimized web presence, the at least one landing page, the at least one mobile-optimized landing page, the at least one marketing campaign, and the at least one mobile-optimized marketing campaign.

In some embodiments, accessing business information may further include providing a user interface configured to receive the business information from a user. The business information may include one or more of business category information, business name information, brand name information, trademark information, and a business offering.

The mobile-optimized web presence may include at least one of a website, a search engine local places listing, a directory listing, an Internet Yellow Pages listing, a data provider listing, a mapping service listing, a social networking profile page, a microblogging profile page and a social pinning profile page. The mobile-optimized marketing campaign may include at least one of a video campaign, a paid search campaign, a display advertising campaign, a paid microblogging message campaign, a coupon promotion campaign, a group purchasing promotion campaign and a remarketing campaign.

In some embodiments, the mobile-optimized marketing campaign may include a social media campaign. The social media campaign may include at least one of a social sharing campaign, a social pinning campaign, a social voting campaign, a social follow campaign, a social like campaign, a social contest campaign and a social survey campaign.

In some embodiments, the method may further include acts of determining at least one of a height, a width and an orientation of a mobile device; and formatting the at least one mobile-optimized web presence in response to the determining act. In other embodiments, the method may include acts of determining at least one of a height, a width and an orientation of a mobile device; and formatting the at least one mobile-optimized landing page in response to the determining act. In other embodiments, the method may include acts of determining at least one of a height, a width and an orientation of a mobile device; and formatting the at least one mobile-optimized marketing campaign in response to the determining act.

In some embodiments, the business information may include at least one of business name information, brand name information, and trademark information and the act of generating at least one marketing campaign may include an act of creating an advertisement including a title containing the at least one of business name information, brand name information, and trademark information. In other embodiments, the act of generating at least one mobile-optimized marketing campaign may further include an act of creating an advertisement including a title containing the at least one of business name information, brand name information, and trademark information.

In some embodiments, the business information may include a business offering and the act of generating at least one marketing campaign may further include an act of creating an advertisement including a title containing the business offering. In some embodiments, the act of generating at least one mobile-optimized marketing campaign may further include an act of creating an advertisement including a title containing the business offering. In some embodiments, the act of generating at least one landing page may further include an act of looking up a keyword associated with the business offering. In some embodiments, the act of generating at least one mobile-optimized landing page may further include an act of looking up a keyword associated with the business offering. In some embodiments, the act of generating at least one marketing campaign may further include an act of looking up a keyword associated with the business offering. In some embodiments, the act of generating at least one mobile-optimized marketing campaign may further include an act of looking up a keyword associated with the business offering.

In some embodiments, the business information may include geographic information and the act of generating at least one web presence may further include an act of creating an HTML web page including a geographic location based on the geographic information. In some embodiments, the act of generating at least one marketing campaign may further include an act of creating an advertisement including a title containing a geographic location based on the geographic information. In some embodiments, the act of generating at least one marketing campaign may further include an act of creating an advertisement that is geo-targeted based on the geographic information. In some embodiments, the act of generating at least one marketing campaign may further include an act of displaying a map based on the geographic information. In some embodiments, the act of generating at least one mobile-optimized marketing campaign may further include an act of creating an advertisement including a title containing a geographic location based on the geographic information.

In some embodiments, the business information may include hours of operation. The act of generating at least one mobile-optimized web presence may further include an act of displaying the hours of operation. In other embodiments, the act of generating at least one mobile-optimized marketing campaign may further include an act of displaying the hours of operation.

In some embodiments, the act of generating at least one marketing campaign may further include an act of creating an advertisement including a formula-built title. The act of generating at least one mobile-optimized marketing campaign may further include an act of creating an advertisement including a formula-built title. The act of generating at least one marketing campaign may further include an act of creating an advertisement including a formula-built body text. The act of generating at least one mobile-optimized marketing campaign may further include an act of creating an advertisement including a formula-built body text. The act of generating at least one marketing campaign may further include an act of creating an advertisement including a generic body text. The act of generating at least one mobile-optimized marketing campaign may further include an act of creating an advertisement including a generic body text.

In some embodiments, the at least one web presence, the at least one mobile-optimized web presence, the at least one landing page and the at least one mobile-optimized landing page may all be located on a same domain. In some embodiments, the at least one web presence, the at least one mobile-optimized web presence, the at least one landing page and the at least one mobile-optimized landing page may all be located on a same subdomain. In other embodiments, the method for generating a web presence may further include an act of hosting at least one of the at least one web presence, the at least one web presence, the at least one mobile-optimized web presence, the at least one landing page and the at least one mobile-optimized landing page on a domain. The method may further comprise an act of provisioning a domain name system service to resolve the domain. In other embodiments, the method may further comprise an act of obtaining the domain.

In some embodiments, the act of generating a web presence may further include an act of applying at least one search engine optimization technique to the web presence. For example, in embodiments wherein the web presence includes an HTML tag and the business information includes a business offering, the method of generating a web presence may further include looking up a keyword associated with the business offering, and the act of applying at least one search engine optimization technique to the web presence may further include inserting the keyword in the HTML tag. The HTML tag may be a title tag. In other embodiments, applying at least one search engine optimization technique may include at least one of optimizing keyword density on the web presence, optimizing an HTML meta tag, and obtaining external links to the web presence.

In some embodiments, the act of generating a mobile-optimized web presence may further include an act of applying at least one search engine optimization technique to the mobile-optimized web presence. For example, in embodiments wherein the mobile-optimized web presence includes an HTML tag and the business information includes a business offering, the method of generating a web presence may further include looking up a keyword associated with the business offering, and the act of applying at least one search engine optimization technique to the mobile-optimized web presence may further include inserting the keyword into the HTML tag of the mobile-optimized web presence. The HTML tag may be a title tag.

In some embodiments, the method for generating a web presence may further include an act of adding an analytics tracking code to at least one of the at least one web presence, the at least one mobile-optimized web presence, the at least one landing page, the at least one mobile-optimized landing page, the at least one marketing campaign and the at least one mobile-optimized marketing campaign.

According to another aspect, there is provided a system comprising a memory configured to store business information, and a processing unit. The processing unit may be operative to access the business information; generate at least one web presence based on the business information; generate at least one mobile-optimized web presence based on the business information, the at least one mobile-optimized web presence being generated independently from the at least one web presence; generate at least one landing page based on the business information; generate at least one mobile-optimized landing page based on the business information, the at least one mobile-optimized landing page being generated independently from the at least one landing page; generate at least one marketing campaign based on the business information; generate at least one mobile-optimized marketing campaign based on the business information; associate the at least one marketing campaign with the at least one web presence and the at least one landing page; and associate the at least one mobile-optimized marketing campaign with the mobile-optimized web presence and the at least one mobile-optimized landing page.

According to another aspect, a computer-readable medium comprises computer-executable instructions that, when executed on a processor of a computer, perform a method for generating a web presence. The method may comprise acts of accessing, over a computer network, business information; generating at least one web presence based on the business information; generating at least one mobile-optimized web presence based on the business information, the at least one mobile-optimized web presence being generated independently from the at least one web presence; generating at least one landing page based on the business information; generating at least one mobile-optimized landing page based on the business information, the at least one mobile-optimized landing page being generated independently from the at least one landing page; generating at least one marketing campaign based on the business information; generating at least one mobile-optimized marketing campaign based on the business information; associating the at least one marketing campaign with the at least one web presence and the at least one landing page; and associating the at least one mobile-optimized marketing campaign with the mobile-optimized web presence and the at least one mobile-optimized landing page.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 illustrates an exemplary computer system upon which various aspects of the present embodiments may be implemented;

FIG. 2 illustrates an exemplary embodiment of a system for establishing a web presence and a mobile-optimized web presence according to aspects of the present invention;

FIG. 3 illustrates an exemplary embodiment of a system for generating a web presence, a landing page, a marketing campaign and a mobile-optimized web presence, a mobile-optimized landing page and a mobile-optimized marketing campaign according to aspects of the present invention;

FIG. 4 illustrates an exemplary embodiment of a database used in the system of FIG. 3;

FIG. 5 illustrates an exemplary user interface in accordance with an embodiment;

FIG. 6 illustrates one example of a webpage generated according to aspects of the present invention;

FIG. 7 illustrates one example of a landing page generated according to aspects of the present invention; and

FIG. 8 is a flow chart illustrating an exemplary process of establishing a web presence, a landing page, a marketing campaign and a mobile-optimized web presence, a mobile-optimized landing page and a mobile-optimized marketing campaign according to aspects of the present invention.

### DETAILED DESCRIPTION

According to aspects of the present invention, methods and systems are provided for receiving business information and establishing both desktop and mobile-optimized web presences and marketing campaigns using the business information. For example, some embodiments may include creating a web page, a landing page or an advertisement based on the business information. Business information may include data regarding the business, such as business type, name, address, phone, business hours, business offerings, geographic information including one or more geographic locations such as areas served, and the like. Some embodiments may include formatting a mobile-optimized web presence and a mobile-optimized marketing campaign in response to determining the configuration or the type of a mobile device on which the mobile-optimized web presence and the mobile-optimized marketing campaign are being accessed. Some embodiments may further include applying search engine optimization (SEO) techniques to a web presence or a mobile-optimized web presence. One example of an SEO technique includes obtaining external links to increase importance attributed to a web presence by a search engine. Another example includes utilizing a keyword that is desirable for a web page to rank for in an HTML title tag.

One or more of these features may be implemented on one or more computer systems coupled by a network (e.g., the Internet). Example systems upon which various aspects are implemented, as well as exemplary methods performed by those systems, are discussed in more detail below.

A web presence may include a website and/or other online venue having an associated profile. For example, a web presence may include a social networking profile page, such as a Facebook page, a Twitter profile, a Foursquare check-in profile, a YouTube Channel, a microblogging profile page, a social pinning profile page and the like. A web presence may be a search engine local places listing, a directory listing, or an internet Yellow Pages listing. One example of a search engine local places listing is Google+ Pages for Businesses, originally created to facilitate display of name, address and phone information in search engine results. A local places listing of a business may include, for example, multiple pages, customer reviews, customer testimonials, hours of operation of the business, one or more locations associated with the business, business offerings, areas served, a map and/or driving directions. A local place listing is therefore similar to a mini website.

A web presence may also include, for example, one or more name/address/phone business listings on various websites. Examples include data provider listings and mapping service listings. For instance, data provider services such as Infogroup, Axciom, and Localeze data cleanse, de-duplicate, and update listings that are then relayed to various websites. Map data provider services such as Mapquest, Navteq, and Teleatlas perform a similar function for mobile navigation information. Vertical-oriented business listings sites such as, for instance, Justia, Martindale, and Bestlawyers perform a similar function for law-oriented websites.

In some embodiments, a web presence may include one or more web presences as described herein. Aspects of the present invention are directed to generating and maintaining one or more web presences and mobile versions thereof, from simple listings all the way through dedicated web pages and even a company website.

Establishing a marketing campaign or a mobile-optimized marketing campaign may include exposing one or more advertisements to one or more end users, based on some criteria, with some exposures resulting in an action by the one or more end users. For example, an action by the one or more end users may include a click.

A marketing campaign may include a landing page. A landing page may be a web page specifically designed to be linked to one or more marketing campaigns, with the intention of improving the probability that a user may take some action when they visit the landing page via an advertisement, rather than visiting a more generic page or an overall web presence.

A marketing campaign may include an advertisement associated with the web presence of a business, and may further be associated with a landing page such that clicking on the advertisement may direct a customer to the landing page. Components of a marketing campaign, for paid search marketing campaigns, may include keywords, groupings of keywords, ads, and display and destination URL information to connect advertisements with landing pages.

A marketing campaign may include one or more of a video campaign, a paid search campaign, a display advertising campaign, a paid microblogging message campaign, a coupon promotion campaign, a group purchasing promotion campaign, a remarketing campaign and the like. It is to be appreciated that a marketing campaign may target other emerging marketing channels or online advertising venues. One example of a paid microblogging message campaign may be based on a microblogging platform such as Twitter, which provides capabilities for advertisers to purchase promoted postings (sponsored tweets), in addition to the common practice of paying individuals such as celebrities, either directly or through a third-party, to issue a promotional tweet from their account (paid tweets).

A marketing campaign may include a social media campaign, including one or more of a social sharing campaign, a social pinning campaign, a social voting campaign, a social contest campaign, a social follow campaign, a social like campaign, and a social survey campaign. For example, social voting platforms such as Digg and Reddit allow users to post content which is then voted up or down by other users. Social networking platforms such as Facebook and Google+ allow users to vote, similarly, but only by voting up (i.e. Facebook's “like” button or Google+'s “+1” button are up votes). Social check-in platforms such as Foursquare allow advertisers to provide promotions and coupons when users physically check-in to a location. Group discount sites such as Groupon allow advertisers to provide group discounts to users. Social pinning websites such as Pinterest allow users to pin pictures from web pages into collections, in a fashion akin to scrapbooking. While social pinning is a relatively new area where monetization approaches have not yet appeared, a social pinning campaign as used herein may include paid pins, i.e. paying individual users to pin content into their accounts, and sponsored pins, i.e. paying Pinterest to feature pinned content on the social pinning site. These advertising approaches would be akin to paid tweets and sponsored tweets. Social platforms may also be used to perform surveys or initiate contests.

Marketing campaign channels, such as some described above, may provide web presences that businesses need to claim or create. For example, web presences associated with marketing channels may include profiles, and increasingly complex description pages that may eventually evolve to mini-websites similar to Google+Pages for Businesses. Claiming or generating a web presence needed by a marketing channel may include associating the web presence with a business, and verifying the association with the business, for example via email, phone, or postcard verification. Web presences associated with some marketing channels may differ from other types of web presences such as a business's website. For example, marketers may be very limited in the information they can input and the display format of web presences associated with some marketing channels. Furthermore, with some web presences, marketers cannot add additional content or pages, and they may not have the option of inserting analytics tracking code that they control into their web presence for tracking. Therefore, in these cases, marketers may have to rely on the trustworthiness of the service hosting the web presence for performance reporting.

As used herein, marketer and user may be used interchangeably and may include a user of the systems and methods disclosed herein, an entity on whose behalf a user is acting, or any entity associated with online marketing, without limitation. In one example, a user may be a business owner, a merchant, or a representative of a small business. In another example, a user may be at least one of a web marketing solution provider and a business representative purchasing a web marketing solution from the provider.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements, and features discussed in connection with any one or more embodiments are not intended to be excluded from a similar role in any other embodiment.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

Computer System

Various aspects and functions described herein in accord with the present invention may be implemented as hardware, software, or a combination of hardware and software on one or more computer systems. There are many examples of computer systems currently in use. Some examples include, among others, network appliances, personal computers, workstations, mainframes, networked clients, servers, media servers, application servers, database servers, web servers, and virtual servers. Other examples of computer systems may include mobile computing devices, such as cellular phones and personal digital assistants, and network equipment, such as load balancers, routers and switches. Additionally, aspects in accord with the present invention may be located on a single computer system or may be distributed among a plurality of computer systems connected to one or more communication networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Further, aspects may be implemented in software, hardware or firmware, or any combination thereof. Thus, aspects in accord with the present invention may be implemented within methods, acts, systems, system placements and components using a variety of hardware and software configurations, and the invention is not limited to any particular distributed architecture, network, or communication protocol. Furthermore, aspects in accord with the present invention may be implemented as specially-programmed hardware and/or software.

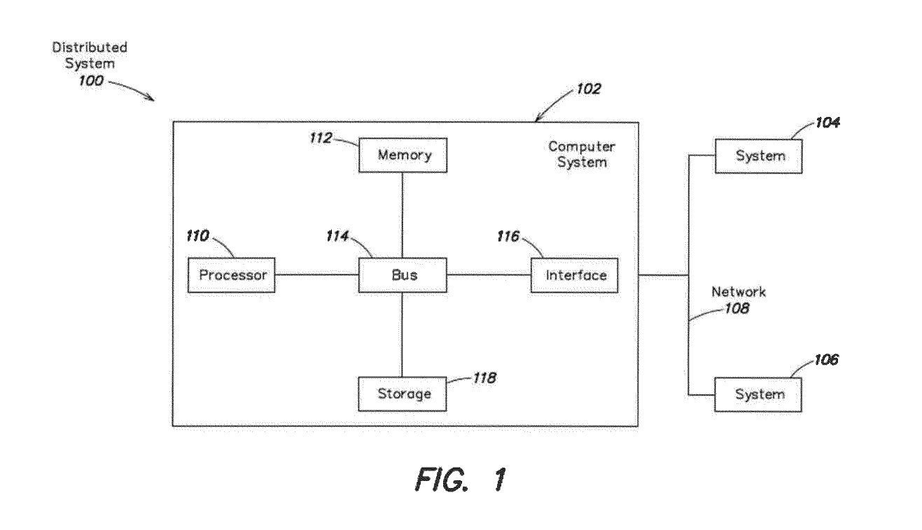

FIG. 1 shows a block diagram of a distributed computer system 100, in which various aspects and functions in accord with the present invention may be practiced. The distributed computer system 100 may include one more computer systems. For example, as illustrated, the distributed computer system 100 includes three computer systems 102, 104 and 106. As shown, the computer systems 102, 104 and 106 are interconnected by, and may exchange data through, a communication network 108. The network 108 may include any communication network through which computer systems may exchange data. To exchange data via the network 108, the computer systems 102, 104 and 106 and the network 108 may use various methods, protocols and standards including, among others, token ring, Ethernet, Wireless Ethernet, Bluetooth, TCP/IP, UDP, HTTP, FTP, SNMP, SMS, MMS, SS7, JSON, XML, REST, SOAP, CORBA IIOP, RMI, DCOM, and Web Services. To ensure data transfer is secure, the computer systems 102, 104 and 106 may transmit data via the network 108 using a variety of security measures including TSL, SSL, or VPN, among other security techniques. While the distributed computer system 100 illustrates three networked computer systems, the distributed computer system 100 may include any number of computer systems, networked using any medium and communication protocol.

Various aspects and functions in accord with the present invention may be implemented as specialized hardware or software executing in one or more computer systems including the computer system 102 shown in FIG. 1. As depicted, the computer system 102 includes a processor 110, a memory 112, a bus 114, an interface 116 and a storage system 118. The processor 110, which may include one or more microprocessors or other types of controllers, can perform a series of instructions that manipulate data. The processor 110 may be a well-known, commercially available processor such as an Intel Pentium, Intel Atom, ARM Processor, Motorola PowerPC, SGI MIPS, Sun UltraSPARC, or Hewlett-Packard PA-RISC processor, or may be any other type of processor or controller as many other processors and controllers are available. The processor 110 may be a mobile device or smart phone processor, such as an ARM Cortex processor, a Qualcomm Snapdragon processor, or an Apple processor. As shown, the processor 110 is connected to other system placements, including a memory 112, by the bus 114.

The memory 112 may be used for storing programs and data during operation of the computer system 102. Thus, the memory 112 may be a relatively high performance, volatile, random access memory such as a dynamic random access memory (DRAM) or static memory (SRAM). However, the memory 112 may include any device for storing data, such as a disk drive or other non-volatile storage device, such as flash memory or phase-change memory (PCM). Various embodiments in accord with the present invention can organize the memory 112 into particularized and, in some cases, unique structures to perform the aspects and functions disclosed herein.

Components of the computer system 102 may be coupled by an interconnection element such as the bus 114. The bus 114 may include one or more physical busses (for example, busses between components that are integrated within a same machine), and may include any communication coupling between system placements including specialized or standard computing bus technologies such as IDE, SCSI, PCI and InfiniBand. Thus, the bus 114 enables communications (for example, data and instructions) to be exchanged between system components of the computer system 102.

Computer system 102 also includes one or more interface devices 116 such as input devices, output devices, and combination input/output devices. The interface devices 116 may receive input, provide output, or both. For example, output devices may render information for external presentation. Input devices may accept information from external sources. Examples of interface devices include, among others, keyboards, mouse devices, trackballs, microphones, touch screens, printing devices, display screens, speakers, network interface cards, etc. The interface devices 116 allow the computer system 102 to exchange information and communicate with external entities, such as users and other systems.

Storage system 118 may include a computer-readable and computer-writeable nonvolatile storage medium in which instructions are stored that define a program to be executed by the processor. The storage system 118 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. A medium that can be used with various embodiments may include, for example, optical disk, magnetic disk, or flash memory, among others. In operation, the processor 110 or some other controller may cause data to be read from the nonvolatile recording medium into another memory, such as the memory 112, that allows for faster access to the information by the processor 110 than does the storage medium included in the storage system 118. The memory may be located in the storage system 118 or in the memory 112. The processor 110 may manipulate the data within the memory 112, and then copy the data to the medium associated with the storage system 118 after processing is completed. A variety of components may manage data movement between the medium and the memory 112, and the invention is not limited thereto.

Further, the invention is not limited to a particular memory system or storage system. Although the computer system 102 is shown by way of example as one type of computer system upon which various aspects and functions in accord with the present invention may be practiced, aspects of the invention are not limited to being implemented on the computer system, shown in FIG. 1. Various aspects and functions in accord with the present invention may be practiced on one or more computers having different architectures or components than that shown in FIG. 1. For instance, the computer system 102 may include specially-programmed, special-purpose hardware, such as for example, an application-specific integrated circuit (ASIC) tailored to perform a particular operation disclosed herein. Another embodiment may perform the same function using several general-purpose computing devices running MAC OS System X with Motorola PowerPC processors and several specialized computing devices running proprietary hardware and operating systems.

The computer system 102 may include an operating system that manages at least a portion of the hardware placements included in computer system 102. A processor or controller, such as processor 110, may execute an operating system which may be, among others, a Windows-based operating system (for example, Windows NT, Windows 2000/ME, Windows XP, Windows 7, or Windows Vista) available from the Microsoft Corporation, a MAC OS System X operating system available from Apple Computer, one of many Linux-based operating system distributions (for example, the Enterprise Linux operating system available from Red Hat Inc.), a Solaris operating system available from Sun Microsystems, or a UNIX operating systems available from various sources. The operating system may be a mobile device or smart phone operating system, such as Windows Mobile, Android, or iOS. Many other operating systems may be used, and embodiments are not limited to any particular operating system. The computer system 102 may include a virtualization feature that hosts the operating system inside a virtual machine (i.e. a simulated physical machine). Various components of a system architecture could reside on individual instances of operating systems inside separate “virtual machines”, thus running somewhat insulated from each other.

The processor and operating system together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, functions in accord with aspects of the present invention may be implemented using an object-oriented programming language, such as SmallTalk, JAVA, C++, Ada, or C# (C-Sharp). Other object-oriented programming languages may also be used. Alternatively, procedural, scripting, or logical programming languages may be used.

Additionally, various functions in accord with aspects of the present invention may be implemented in a non-programmed environment (for example, documents created in HTML, XML or other format that, when viewed in a window of a browser program, render aspects of a graphical-user interface or perform other functions). Further, various embodiments in accord with aspects of the present invention may be implemented as programmed or non-programmed placements, or any combination thereof. For example, a web page may be implemented using HTML while a data object called from within the web page may be written in C++. Thus, the invention is not limited to a specific programming language and any suitable programming language could also be used.

A computer system included within an embodiment may perform functions outside the scope of the invention. For instance, aspects of the system may be implemented using an existing product, such as, for example, the Google search engine, the Yahoo search engine available from Yahoo! of Sunnyvale, Calif., or the Bing search engine available from Microsoft of Seattle Wash. Aspects of the system may be implemented on database management systems such as SQL Server available from Microsoft of Seattle, Wash.; Oracle Database from Oracle of Redwood Shores, Calif.; and MySQL from Sun Microsystems of Santa Clara, Calif.; or integration software such as WebSphere middleware from IBM of Armonk, N.Y. However, a computer system running, for example, SQL Server may be able to support both aspects in accord with the present invention and databases for sundry applications not within the scope of the invention.

In addition, the method described herein may be incorporated into other hardware and/or software products, such as a web publishing product, a web browser, or an internet marketing or search engine optimization tool.

Example System Architecture

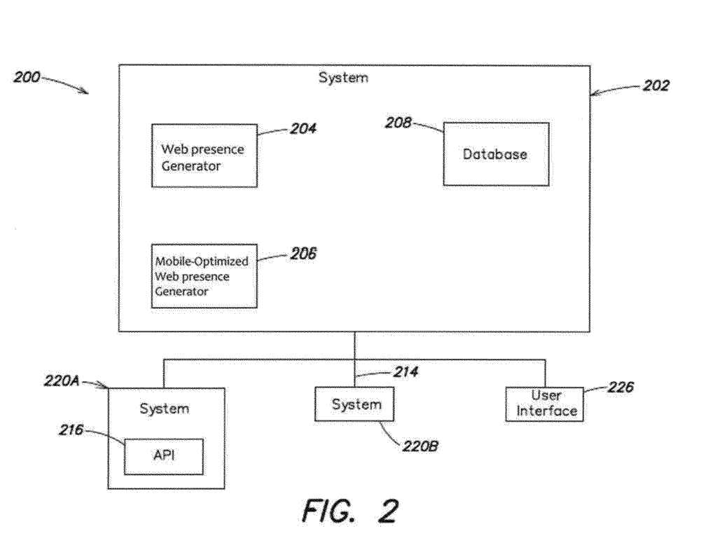

An example system in accordance with aspects of the invention can be seen in FIG. 2. The distributed system 200 may be used by a marketer or user for establishing a web presence and a mobile-optimized web presence. The user may be acting, for example, on behalf of a business.

The distributed system 200 includes a system 202. The system 202 may be a personal computer, a network appliance, a mainframe terminal, PDA, tablet computer, or any other computer system known in the art. The distributed system 200 may also include a user interface 226 for allowing the user to interact with the distributed system 200 and/or the system 202. The user interface 226 may be configured to access information from a user. The information may include, for example, business information, such as the name, address, contact information, and offerings of a business. The user interface may be configured to communicate with the system 202 over a computer network.

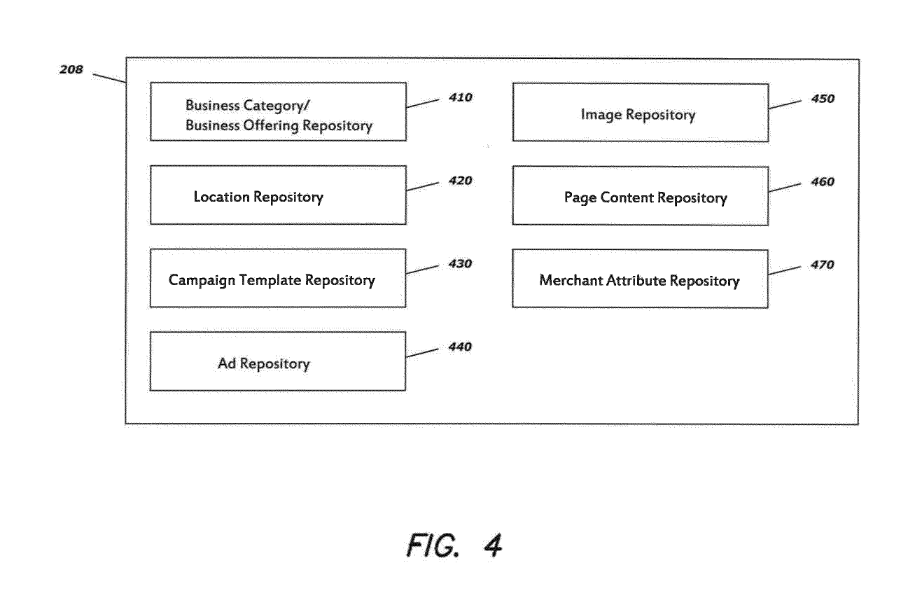

The system 202 includes a web presence generator 204 and a mobile-optimized web presence generator 206. The system 202 may also include a database 208. The system 202 may be configured to store user data, such as business information that may be used by the web presence generator 204 and the mobile-optimized web presence generator 206, in the database 208, or in another memory location so that it may be accessed at a later time. The database 208 may also store one or more data repositories as shown in FIG. 4 and described in further detail below. The web presence generator 204 and the mobile-optimized web presence generator 206 may be configured to access information stored in the database 208. In other embodiments, the system 202 may include a plurality of databases, or the databases may be part of the web presence generator 204 and the mobile-optimized web presence generator 206. In other embodiments, the database may be located external to the system 202, and information in the database may be accessed via a computer network. In yet other embodiments, the information may be accessed via the user interface 226 and communicated directly to the web presence generator 204 and the mobile-optimized web presence generator 206, without the use of a database.

The web presence generator 204 is configured to generate a desktop version of one or more web presences disclosed herein. Web presences may be generated based on information stored in the database 208 and/or information received from the user interface 226. The web presence generator 204 may further be configured to activate or deploy the one or more web presences that are generated. The web presence generator 204 may further be configured to add an analytics tracking code to one or more web presences. An analytics tracking code may be used, for example, to track the performance of a web presence, such as the number of visits to a web page, or particular actions by a user such as conversions. Conversions may include, for example, product sales occurrences, product sale units, product sale amounts, contact form submissions, or phone calls.

Still referring to FIG. 2, the system 202 further includes a mobile-optimized web presence generator 206. The mobile-optimized web presence generator 206 is configured to generate a mobile-optimized version of one or more web presences disclosed herein. Mobile-optimized versions of one or more web presences are generated independently from the web presences generated by the web presence generator 204. Mobile-optimized web presences may be generated based on information stored in the database 208 and/or information received from the user interface 226.

The mobile-optimized web presence generator 206 may further include a subsystem (not shown) configured to determine a configuration of a mobile device, such as a height, width, or an orientation, and may further be configured to format a mobile-optimized web presence in response to determining a configuration or a type of the mobile device. The system 220B shown in FIG. 2 and discussed further below may be a mobile device. In other embodiments, a subsystem for determining a configuration of a mobile device and formatting the mobile-optimized web presence may be separate from the mobile-optimized web presence generator 206 in the system 202 and may be configured to communicate with the mobile-optimized web presence generator.

In some embodiments, the system 202 may be configured to check screen height and width and make a determination that based on those dimensions, a mobile web browser is being used, and even to discern the orientation of the device, such as landscape or portrait. For example, some embodiments may be configured to identify an orientation of iPhone and Android smart phones by checking screen height and width. In other embodiments, the system 202 may include javascript code to determine screen orientation. For example, Apple iPad does not currently change height and width numbers when its orientation is changed, necessitating the use of javascript code to determine screen orientation.

The mobile web presence generator 206 may further be configured to activate or deploy the one or more mobile-optimized web presences that are generated. The web presence generator 206 may further be configured to add an analytics tracking code to one or more mobile-optimized web presences. In other embodiments, the system 202 may be configured to activate or deploy the one or more web presences and the mobile-optimized web presences. The system 202 may further be configured to insert tracking codes into one or more of the web presences and the mobile-optimized web presences created by the web presence generator 204 and the mobile-optimized web presence generator 206.

The distributed system 200 includes a network interface 214 that may be configured to allow the system 202 to communicate with other systems 220A and/or 220B and/or the user interface 226 over a computer network, for example, the Internet. In some embodiments, the system 202 may be configured to communicate data, such as user data via the user interface 226 and/or data from another system 220A and/or data from the database 208 stored in a format such as CSV, XML, delimited file, flat text file, or other format.

The system 220A may be associated with or controlled by an entity that provides a marketing channel, such as Google, Facebook or Twitter. In some embodiments, the system 202 may be configured to communicate with the other system 220A through the network interface 214 by using an Application Programming Interface (API) 216. The API 216 may be an interface implemented by a software program on the system 220A, thereby allowing the system 202 to interact with the system 220A over the network interface 214. In one example, the API 216 may be a Google AdWords API. Software that is configured to interact with the API 216 may be implemented on the system 202.

In some embodiments, the system 220A may include a system associated with or controlled by an entity that provides an aspect of a web marketing solution. For example, system 220A may include a system that provides templates that may be used by system 202 to generate one or more web presences.

The system 220B may be a computer system or a device for accessing the one or more web presences and mobile-optimized web presences established by the system 202. In one example, the system 220B may be a desktop computer. In other examples, the system 220B may be a mobile device of a customer accessing the web presence, landing page or marketing campaign of a business.

In some embodiments, the system 202 may be a distributed system. For example, each of the web presence generator 204, the mobile-optimized web presence generator 206 and the database 208 may operate on a different computing system.

As used herein, business information may include data that may appear in one or more web presences, landing pages, marketing campaigns, and mobile-optimized versions thereof. Business information may be provided by a user and/or accessed or received via a computer network. For example, a sales person may enter information on the business, such as name, address, phone, business hours, geographic information including one or more geographic locations such as areas served, and the like, as well as business type information via the user interface 226.

Business type information may include business category and one or more business offerings. Examples of business category include plumber or auto repair. A business offering may define business products or services at a more granular level than business category. Not all businesses in the same category may offer the same business offerings. For instance, one business with a business category plumber may perform the business offerings toilet repair, faucet installation, and faucet repair, while another in the same category may perform the business offerings toilet repair, broken pipe repair, water heater installation, and water heater repair. Business offerings in some cases are tied to business categories but in some cases a business may perform business offerings outside of what is typical for their business category. For instance, a company that logically belongs in the business category marketing consulting services may, in addition to performing business offerings such as search optimization services and paid search management services, could also provide a business offering intellectual property consulting services which may otherwise fit better under a legal services or engineering services business category.

Referring again to FIG. 2, the web presence generator 204 and/or the mobile-optimized web presence generator 206 may be configured to create an HTML web page including business information. In some embodiments, the web presence generator 204 and/or the mobile-optimized web generator 206 may be further configured to apply one or more search engine optimization (SEO) techniques to a web presence and/or a mobile-optimized web presence. Application of SEO techniques may result in better rankings in organic search results of search engines such as Google, Yahoo! and Bing. For example, a desktop or a mobile-optimized web presence may include an HTML tag and the web presence generator 204 and/or the mobile-optimized web presence generator 206 may further be configured to look up a keyword associated with the business information and to insert the keyword in the HTML tag. As discussed above, the business information may include a business offering, and one or more of the web presence generator 204 and the mobile-optimized web presence generator 206 may be configured to look up a keyword associated with the business offering. In one example, the HTML tag may be a title tag and a keyword may be inserted into the title tag.

One or more of the web presence generator 204 and the mobile-optimized web presence generator 206 may further be configured to apply other SEO techniques. SEO techniques may include, but are not limited to, targeting each page to one keyword, optimizing keyword density in text on-page, optimizing HTML meta-tags and obtaining external links to improve a page's score and to obtain keyword-rich anchor text, known to be a relevance signal used by search engines. For example, a small business that provides security services in Rhode Island may want to rank highly for the term [security ri]. Hosting the business's web presence on the domain securityri.com, and provisioning DNS services to resolve that domain to the business's server IP address may aid in ranking higher for the term [security ri]. Obtaining anchor text on external websites, in links such as:

<a href=“http://securityri.com/”>Security RI</a>

where Security RI is the anchor text of the link, may further improve organic search rankings.

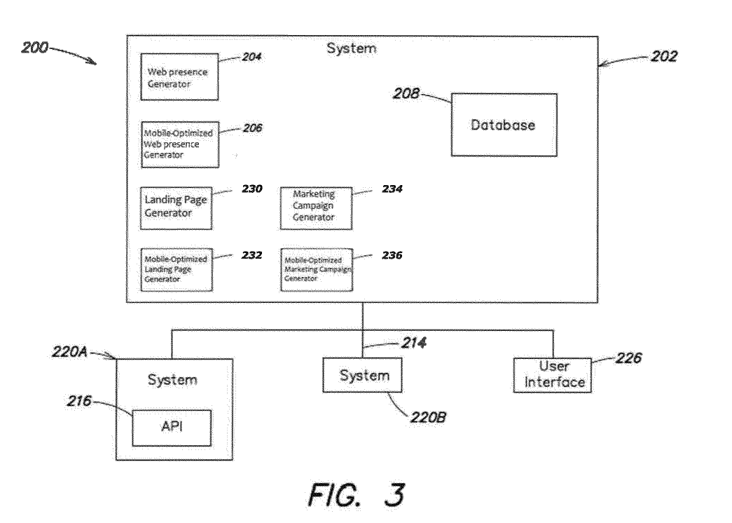

FIG. 3 illustrates the distributed system 200 of FIG. 2, where the system 202 further includes a landing page generator 230, a mobile-optimized landing page generator 232, a marketing campaign generator 234 and a mobile-optimized marketing campaign generator 236. A landing page may be specifically designed for a particular marketing campaign, or may simply constitute a web presence that appears in response to clicking on an advertisement (i.e., one of the web presences such as a home page could be utilized as a landing page if a more specific one is not desired). An advertisement may be a component of a marketing campaign or a mobile-optimized marketing campaign. Similar to the web presence generator 204 and the mobile-optimized web presence generator 206, each of the landing page generator 230, the mobile-optimized landing page generator 232, the marketing campaign generator 234 and the mobile-optimized marketing campaign generator 236 may be configured to communicate with the user interface 226, the database 208, and the systems 220A and 220B.

The landing page generator 230 is configured to generate a desktop version of one or more landing pages. The mobile-optimized landing page generator 232 is configured to generate one or more mobile-optimized landing pages. The marketing campaign generator 234 is configured to generate desktop versions of one or more types of marketing campaigns as described previously. The mobile-optimized marketing campaign generator 236 is configured to generate one or more types of mobile-optimized marketing campaigns. Landing pages, marketing campaigns, mobile-optimized landing pages, and mobile-optimized marketing campaigns may be generated based on information stored in the database 208 and/or information received from the user interface 226. Mobile-optimized landing pages may be generated independently from landing pages generated by the landing page generator 230. Furthermore, mobile-optimized marketing campaigns are generated independently from desktop versions of marketing campaigns.

The landing page generator 230 and the mobile-optimized landing page generator 232 may be configured similarly to the web presence generator 204 and the mobile-optimized web presence generator 206, respectively. In some embodiments, the landing page generator 230 may be included in the web presence generator 204, and the mobile-optimized landing page generator 232 may be included in the mobile-optimized web presence generator 206.

The landing page generator 230, the mobile-optimized landing page generator 232, the marketing campaign generator 234 and the mobile-optimized marketing campaign generator 236 may be configured to activate the one or more landing pages and marketing campaigns and mobile-optimized landing pages and mobile-optimized marketing campaigns. In some embodiments, activating may include deploying on a system 220A as shown in FIGS. 2 and 3. The landing page generator 230, the mobile-optimized landing page generator 232, the marketing campaign generator 234, and the mobile-optimized marketing campaign generator 236 may further be configured to insert tracking codes into one or more landing pages and marketing campaigns and mobile-optimized versions thereof. Tracking codes inserted into one or more of web presences, landing pages, marketing campaigns, and mobile-optimized versions thereof may be pixel tracking tags. In one example, these tags may provide data regarding organic and paid media visitor activity. Pixels may enable reporting organic clicks as well as onsite activities, such as completing a “Contact Us” form, for visitors from most sources. In some embodiments, the system 202 may be configured to retrieve, using the API 216 of system 220A, performance data related to one or more web presences, landing pages, marketing campaigns, and mobile versions thereof generated by the system 202 and deployed on system 220A.

The mobile-optimized landing page generator 232 and/or the mobile-optimized marketing campaign generator 236 may further include subsystems configured to determine a configuration of a mobile device, such as system 220B, and to generate one or more mobile-optimized landing pages and marketing campaigns accordingly. In other embodiments, the system 202 may be configured to determine a configuration of a mobile device and to communicate the configuration to each of the mobile-optimized web presence generator 206, the mobile-optimized landing page generator 232 and the mobile-optimized marketing campaign generator 236.

Still referring to FIG. 3, the system 202 may further be configured to associate one or more marketing campaigns generated by the marketing campaign generator 234 with one or more web presences generated by the web presence generator 204 and one or more landing pages generated by the landing page generator 230. For example, the marketing campaign may include an advertisement associated with the web presence of a business, and may further be associated with a landing page such that clicking on the advertisement may direct a customer to the landing page. The system 202 may further be configured to associate one or more mobile-optimized marketing campaigns generated by the mobile-optimized marketing campaign generator 236 with one or more mobile-optimized web presences generated by the mobile-optimized web presence generator 206 and one or more mobile-optimized landing pages generated by the mobile-optimized landing page generator 232.

In some embodiments, generating a marketing campaign and a mobile-optimized marketing campaign by the marketing campaign generator 234 and the mobile-optimized marketing campaign generator 236, respectively, may include generating an advertisement. The advertisement may include business information. For example, the title of the advertisement may include the business name, a business offering or a geographic location of the business. The advertisement may also include other business information, such as hours of operation, a map, and driving directions. The advertisement may be specifically formatted for presentation on one or more mobile devices. The advertisement may be geo-targeted to a geographic location served by the business (i.e. targeted for presentation only to consumers who are located in and/or interested in one or more geographic locations).

In some embodiments, at least one of the marketing campaign generator 234 and the mobile-optimized marketing campaign generator 236 may use an algorithm to create a title and/or a body text of an advertisement. In other embodiments, at least one of the marketing campaign generator 234 and the mobile-optimized marketing campaign generator 236 may be configured to create an advertisement incorporating a generic body text.

Still referring to FIG. 3, the system 202 and/or one or more of the web presence generator 204, the mobile-optimized web presence generator 206, the landing page generator 230, the mobile-optimized landing page generator 232, the marketing campaign generator 234 and the mobile-optimized marketing campaign generator 236 may be configured to look up a keyword associated with business information. For example, a keyword associated with a business offering may be looked up. One or more keywords may then be used by one or more of the web presence generator 204, the mobile-optimized web presence generator 206, the landing page generator 230, the mobile-optimized landing page generator 232, the marketing campaign generator 234 and the mobile-optimized marketing campaign generator 236 to enable better marketing performance.

Generating a marketing campaign and a mobile-optimized marketing campaign, such as paid search advertisements, may include applying one or more best practices or optimization techniques. For example, a search keyword may ideally be placed in the title of the advertisement, or may have certain words capitalized, or may include a strong “call to action”, and so on.

By way of example, a business named “Foo Plumbing”, with a web presence located at “http://foo.com”, may be in a business category plumbing and may provide a business offering toilet repair. The business offering toilet repair may be associated with a number of keywords related to toilet repair. For instance, potential customers who are online searchers may tend to type brand names of toilets they need repaired. Therefore, american standard toilet repair may be identified as a potential keyword for advertising. An example advertisement or creative may then include the following title, display URL, and two body lines:

American Standard Toilet Repair

www.foo.com/toilet-repair

15 Years Of Success and Experience.

We Can Fix It—Call Us!

Some embodiments may utilize formula-built creatives. An example advertisement title based on a simple formula that prepends the business offering to the phrase “Done Right” might read, for instance “Toilet Repairs Done Right”. Other more complex formulas may involve singular/plural transformations, other word stem transformations, rules, regular expressions, multiple steps, and the like.

Other considerations for generating online marketing campaigns may include landing page design, bid optimization, campaign organization, and identification of which keywords to target.

The system 202 in FIGS. 2 and 3 may further be configured to provide quotes to users who may potentially order a service for establishing one or more web presences, marketing campaigns, landing pages, and mobile-optimized versions thereof. The system 202 may further be configured to create an order. The system 202 may further be configured to provide quality assurance of one or more generated web presences, marketing campaigns, landing pages, and mobile-optimized versions thereof.

The system 202 may be configured to obtain a domain or register a domain name and may be configured to provision a domain name system service to resolve the domain. The system 202 may be configured to host one or more web presences, landing pages, marketing campaigns, and mobile versions thereof. In some embodiments, the system 202 may be configured to host one or more of the web presences, landing pages, marketing campaigns, and mobile versions thereof on a same domain or a same subdomain.

FIG. 4 shows one embodiment of the database 208 in FIG. 3 and FIG. 4. The database 208 may comprise one or more repositories that may be used by the system 202 for establishing one or more web presences, landing pages, marketing campaigns, and mobile-optimized web presences, landing pages, and marketing campaigns. In the exemplary embodiment shown in FIG. 4, the database 208 includes a business category/business offering repository 410. The business category/business offering repository 410 may include a business hierarchy repository, and may store a business category and business offering taxonomy. Business categories may provide navigational assistance and may describe a high-level business type, for example, beauty salons, chiropractors, or plumbers. Business offerings may include the actual types of products or services that a particular business category delivers. For example a beauty salon (a business category) may provide business offerings such as women's hair styling, foils, hair coloring, manicures, pedicures, etc.

In one example, a small-business-targeted taxonomy may contain 500 or more business categories and 2000 or more business offerings. In some embodiments, an initial set of business offerings may be available within the database 208 and the taxonomy may be expanded over time.

When a user purchases a web presence and/or a marketing campaign, such as search engine marketing, the user may select business offerings that they are most interested in targeting via the user interface 226. The user interface 226 may be used to display available business categories and/or business offerings to a user, based on data in the business category/business offering repository 410.

The database 208 may further include a location repository 420. The location repository 420 may include a location taxonomy. The location taxonomy may define geographic locations hierarchically. For example, a location hierarchy may include Country, State, Region, City/Town, and Postal Code. A location hierarchy may also include aliases and other common names to be used for navigation and targeting. In some embodiments, a user may select, from a location repository 420, one or more geographic locations in which they want to target their advertising.

The database 208 may further include a campaign template repository 430, as shown in FIG. 4. In one example, a set of keywords may be created for each business offering and stored in the campaign template repository 430. Keywords stored in a campaign template repository 430 may be used when creating marketing campaigns for a corresponding business offering.

The database 208 may further include an ad repository 440, as shown in FIG. 4. The ad repository 440 may include generic advertisement templates that may be used to create one or more marketing campaigns and/or mobile-optimized marketing campaigns. In one embodiment, a set of ads including a headline, a first description line, and a second description line may be created and stored for each business offering. In some embodiments, the ad repository 440 may be used by the marketing campaign generator 234 and/or the mobile-optimized marketing campaign generator 236 in FIG. 3.

The database 208 may further include an image repository 450. The image repository 450 may include an image library with one or more images available in the library for each business offering in the taxonomy. The image repository 450 may include logos, pictures of business locations, pictures of clients, pictures of the business in operation, and so forth.

The database 208 may further include a page content repository 460. The page content repository may include a set of descriptive sentences that may be used, for example, to populate a website and/or a landing page such as a search engine marketing landing page. The sentences in the repository may include text specific to one or more business offerings. In some embodiments, the sentences in the repository may be selected according to one or more algorithms and inserted into one or more landing pages or web presences. In one example, the sentences in the repository may be randomly selected.

The database 208 may further include a merchant attribute repository 470. Merchant attributes may include merchant-specific text chosen or supplied by a merchant, a user, or a marketer to describe specifics about a business and/or service. Examples of merchant attributes include “Free Parking Available in Rear,” “Open 7 Days a Week,” “Open until 8:00 pm on Thursdays,” etc. In some embodiments, the merchant attribute repository 470 may provide a limited number of choices, for example, 10 to 20 generic merchant attribute examples and 3 to 10 category specific merchant attributes. A user may be presented with generic and category specific attributes to select from. The system 202 may be configured to allow a user to enter merchant attributes using any combination of predefined repository-based examples verbatim, edited variations of the repository-based examples, or attributes entered as free-form text. The system 202 may be configured to allow merchant attributes to be modified by a user, for example via the user interface 226. In some embodiments, the merchant attribute repository 470 may be configured to store business information or any other business specific data provided by a user of the system 202.

In some embodiments, the database 208 may be configured to receive input from external sources, for example, a user input device having a user interface 226, and format that input into the information to be stored by the database 208. Data stored in any of the repositories in the database 208 may be used by the system 202 and one or more of the web presence generator 204, the mobile-optimized web presence generator 206, the landing page generator 230, the mobile-optimized landing page generator 232, the marketing campaign generator 234 and the mobile-optimized marketing campaign generator 236 in FIG. 3.

The database 208 may be a relational database or any other method of storing data known in the art, such as XML, flat file, or spreadsheet, or other location in a computer memory. The database 208 may be a commercial database product, such as IBM DB2, Microsoft SQL Server, MySQL, Openbase, Sybase, or other database product. The database 208 may store textual information and/or binary information, and may store textual information as plain text, or may encode it in binary or other format.

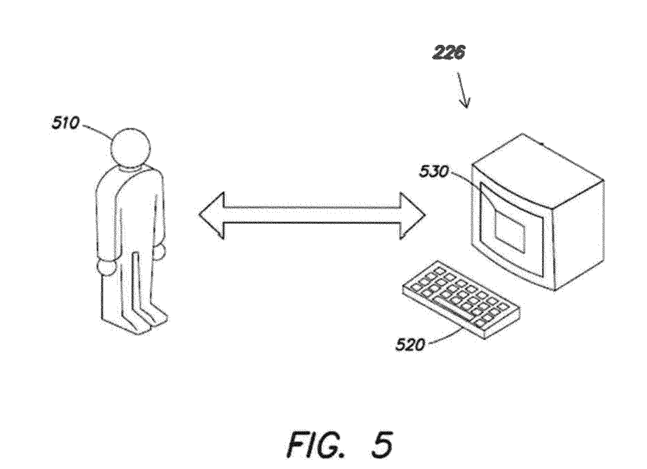

FIG. 5 illustrates a block diagram of one example of a user interface 226. The user interface 226 may allow a user 510 to interact with the user interface 226 through the use of a user input device 520. The user input device 520 may be of any type known in the art, such as a keyboard, mouse device, trackball, microphone, touch screen, printing device, or display screen. The user interface 226 may display an indication 530 in response to the input entered by the user 510. For example, the indication 530 may indicate whether the user input is valid.

The user interface 226 may allow the user 510 to select, input, vary, or adjust business information. For example, the user interface 226 may allow for the selection or input of a numerical value, such as through a text box, slider, pull down menu, or other element for receiving input. In some embodiments, the user interface 226 may allow for some business information to be selected or adjusted graphically, for example, on a graph or chart. In some embodiments, information may be entered by a user into a text box on a webpage via the user interface 226. In other embodiments, a user may upload a file that has previously been populated with information. In other embodiments, the system 202 may maintain a database of potential inputs, such as business offerings and geographic locations, and the user may select inputs from the database.

In some embodiments, the user interface 226 may allow for a rule-based scheme to be controlled. For example, the user interface 226 may allow the user 510 to enter one or more rules or conditions for establishing the one or more web presences, landing pages, marketing campaigns and mobile-optimized web presences, landing pages, and marketing campaigns.

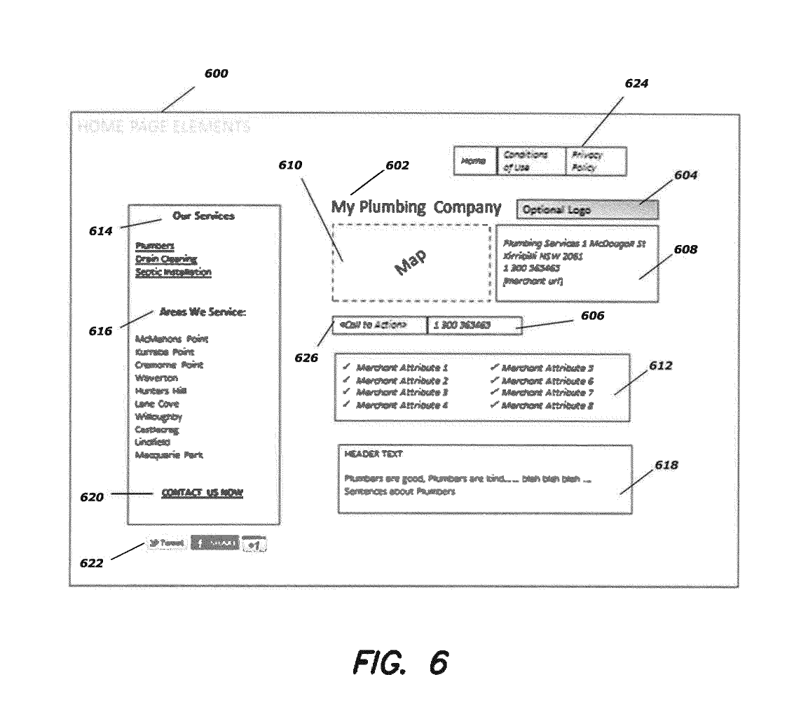

FIG. 6 illustrates one example of a web page 600 generated by the web presence generator 204 in FIG. 3. The web page 600 includes a business name 602 and may also include a logo 604. The web page 600 includes phone number information 606 and contact information 608 which may include business address, business phone number, email address, merchant (i.e., business) URL, etc. The web page 600 may include a map 610 and may also include driving directions. The web page 600 may include one or more merchant attributes 612, a list of business offerings 614, and a list 616 of geographic locations or areas serviced. One or more of business offerings and geographic locations may link to other pages of the website, such as one or more business offering pages. The web page 600 may further include descriptive text 618 describing the primary business offering. The web page 600 may include other links such as a contact link 620, links 622 to social networking sites, or links to web presences of the business hosted by social networking sites. The web page 600 may further include links 624 to a privacy policy and conditions of use associated with the web presence. The web page 600 may include a Call to Action 626, such as the phrase “Call Now” (if associated with a displayed phone number), or a button labeled “Click here to register for a Webinar”, or “Click here to have a representative contact you”, for example. The call to action 626 may invoke a lead capture page, a click-to-call action, or other lead generation-associated activity. In other embodiments, the web page 600 may include other business information and may be arranged in another layout.

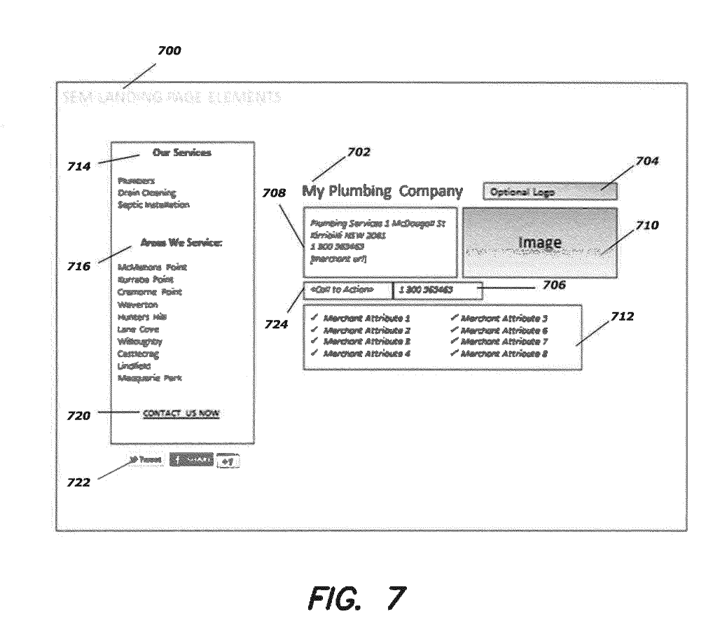

FIG. 7 illustrates one example of a landing page 700 generated by the landing page generator 230 in FIG. 3. The landing page 700 includes a business name 702 and may also include a logo 704. The landing page 700 includes phone number information 706 and contact information 708 which may include business address, business phone number, email address, merchant URL, etc. The landing page 700 may include a Call to Action 724, such as the phrase “Call Now” (if associated with a displayed phone number), or a button labeled “Click here to register for a Webinar”, or “Click here to have representative contact you”, for example. The call to action 724 may invoke a lead capture page, a click-to-call action, or other lead generation-associated activity. The landing page 700 may include an image 710 associated with the business. The landing page 700 may include one or more merchant attributes 712, a list of business offerings 714 and a list 716 of geographic locations or areas serviced. One or more of business offerings and geographic locations may link to other pages of the web presence associated with the landing page 700. The landing page 700 may include other links such as a contact link 720, links 722 to social networking sites or to web presences of the business hosted by social networking sites. In some embodiments, the landing page 700 may include one or more customer testimonials or customer reviews. In other embodiments, the landing page 700 may include other business information and may be arranged in another layout.

One or more web presences, landing pages, mobile-optimized web presences, and mobile-optimized landing pages may be generated by the system 202 in FIG. 3 using templates that may be stored in the database 208. For example, a number of website and landing page templates may be provided in the various repositories as shown in FIG. 4. Separate templates may be provided for desktop and mobile-optimized versions of web presences, landing pages and marketing campaigns. In some embodiments, web page and landing page templates may support a set of common elements such as business or merchant name, merchant logo or standard image, such as from the image repository 450, one or more merchant business addresses, link to a merchant website, phone number, a map which may be linked to a map provider page, a Call to Action, a Contact Us form, one or more merchant attributes, customer testimonials, customer reviews, and social networking site links. Templates may also support multiple styles or default color combinations. In some embodiments, the system 202 may deploy one or more web presences, landing pages, marketing campaigns, mobile-optimized web presences, mobile-optimized landing pages, and mobile-optimized marketing campaigns generated using randomly selected templates and styles.

Referring again to FIG. 3, the system 202 may further be configured to provide a user interface 226 that allows a user to modify an initially deployed web presence, mobile-optimized web presence, landing page, mobile-optimized landing page, marketing campaign or mobile-optimized marketing campaign. One example of an initially deployed web page may be the web page 600 in FIG. 6, and one example of an initially deployed landing page may be the landing page 700 in FIG. 7. In some embodiments, the user interface 226 may include a function to change merchant attributes, including adding new attributes by selecting and modifying preset attributes from a list available from the database 208 or by adding free-text attributes. The user interface 226 may include a function to upload a logo. Logos may be automatically resized by the system 202 to fit within an allotted space on a template. The user interface 226 may include one or more functions to add, change, delete, or suppress displaying a physical address. The user interface 226 may include functions that allow users to add, change or delete links, such as a link to a website. The user interface 226 may include a function to change one or more templates used to generate one or more desktop and mobile-optimized web presences, landing pages, and marketing campaigns. The user interface 226 may include functions to select alternate images from the database 208, to add or change a Contact Us form address, to view received Contact Us form submissions, to select a primary business offering and/or location, to select or update a map location, to select or update a Call to Action, and to select or update customer testimonials or customer reviews.

The user interface 226 may further include a function to view a reporting dashboard. A reporting dashboard may be configured to report to a user information regarding the performance of one or more web presences, landing pages, marketing campaigns, and mobile-optimized web presences, landing pages and marketing campaigns associated with the user's business. In one example, the dashboard may include information regarding a user's account, unique visitors, Contact Us form submissions, and clicks associated with paid ads.

Exemplary Method

Having described various aspects of a system for establishing one or more web presences, mobile-optimized web presences, landing pages, mobile-optimized landing pages, marketing campaigns and mobile-optimized marketing campaigns, the operation of such a system is now described.

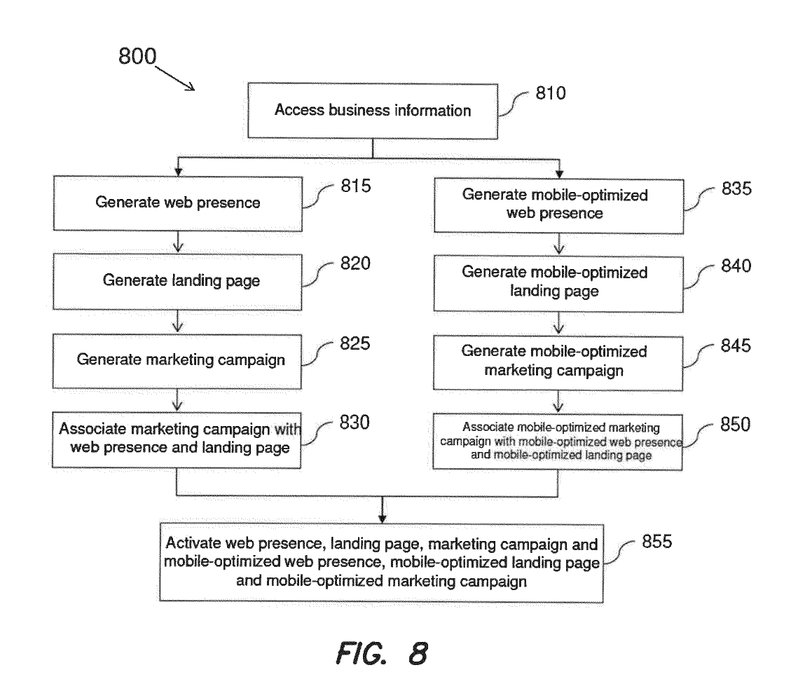

A process according to one embodiment is described with reference to FIG. 8, illustrating an exemplary process 800 of establishing a web presence, a landing page, a marketing campaign and a mobile-optimized web presence, a mobile-optimized landing page and a mobile-optimized marketing campaign according to aspects of the present invention. In some embodiments, the process 800 may be embodied in a module, plugin, or component of an online marketing platform, such as that offered by the Search Agency of Los Angeles, Calif. In other embodiments, the process 800 may be embodied in a stand-alone application that performs the functions described herein.

Process 800 includes accessing business information in act 810. Business information may be accessed, for example, by the system 202 shown in FIG. 3, via a computer network. Business information may be provided by a user via a user interface 226, or may have been previously obtained and stored in a database, such as database 208 in FIG. 4.

In act 815, one or more web presences may be generated, for example, by the web presence generator 204 in FIG. 3. In one example, act 815 may generate a web page 600 as shown in FIG. 6. In act 820, one or more landing pages may be generated, for example, by the landing page generator 230 in FIG. 3. In one example, act 820 may generate a landing page 700 as shown in FIG. 7. In act 825, one or more marketing campaigns may be generated, for example, by the marketing campaign generator 234 in FIG. 3. Acts 815, 820 and 825 may be performed in any order or may be performed substantially in parallel.

In act 835, one or more mobile-optimized web presences may be generated, for example, by the mobile-optimized web presence generator 206 in FIG. 3. In act 840, one or more mobile-optimized landing pages may be generated, for example, by the mobile-optimized landing page generator 232 in FIG. 3. In act 845, one or more mobile-optimized marketing campaigns may be generated, for example, by the mobile-optimized marketing campaign generator 236 in FIG. 3. It is to be appreciated that acts 835, 840 and 845 may be performed in any order or may be performed substantially in parallel.

Any of the acts in process 800 may include using a database 208 as shown in FIG. 4. For example, one or more of acts 815, 820, 825, 835, 840 and 845 may include using templates stored in the database 208 and may further include using business information stored in the database 208 or provided by the user interface 226.

In act 830, a marketing campaign generated in act 825 may be associated with a landing page generated in act 820 and may also be associated with a web presence generated in act 815. Similarly, in act 850, a mobile-optimized marketing campaign generated in act 845 may be associated with a mobile-optimized landing page generated in act 840 and may also be associated with a mobile-optimized web presence generated in act 835. Furthermore, acts 815, 820, 825 and 830 are independent from acts 835, 840, 845 and 850. Therefore, in some embodiments, one or more of acts 815, 820, 825 and 830 may be performed substantially in parallel with one or more of acts 835, 840, 845 and 850.

In the exemplary embodiment in FIG. 8, process 800 further includes activating, in act 855, the web presence generated in act 815, the landing page generated in act 820, the marketing campaign generated in act 830, the mobile-optimized web presence generated in act 835, the mobile-optimized landing page generated in act 840 and the mobile-optimized marketing campaign generated in act 845. Activating may include deploying one or more of the web presence generated in act 815, the landing page generated in act 820, the marketing campaign generated in act 825, the mobile-optimized web presence generated in act 835, the mobile-optimized landing page generated in act 840 and the mobile-optimized marketing campaign generated in act 845. In some embodiments, activating may include hosting one or more of the web presence generated in act 815, the landing page generated in act 820, the marketing campaign generated in act 825, the mobile-optimized web presence generated in act 835, the mobile-optimized landing page generated in act 840 and the mobile-optimized marketing campaign generated in act 845. In one embodiment, act 855 may be performed by the system 202 in FIG. 3.

In some embodiments, process 800 may include checking screen height and width of a device accessing generated content, such as the system 220B in FIG. 3, and making a determination that based on those dimensions, a mobile web browser is being used, and even to discern the orientation of the device, such as landscape or portrait. For example, some embodiments may include identifying orientation of iPhone and Android smart phones by checking screen height and width. In other embodiments, process 800 may include using javascript code in order to determine screen orientation. For example, Apple iPad does not currently change height and width numbers when its orientation is changed, necessitating the use of javascript code to determine screen orientation. Process 800 may further include formatting content generated in any of acts 815, 820, 825, 835, 840 and 845 in response to determining a type or configuration of a device accessing a respective content.

Process 800 may further include applying one or more search engine optimization techniques, as described previously, in one or more of acts 815, 820, 825, 835, 840 and 845. Process 800 may include looking up one or more keywords associated with a business offering provided in act 810. In some embodiments, looking up keywords may be performed in one of more of acts 815, 820, 825, 835, 840 and 845. In some embodiments, one or more of acts 815, 820, 825, 835, 840 and 845 may further include inserting keywords associated with a business offering into their respective generated content.

Generating a web presence, a landing page and a mobile-optimized web presence and a mobile-optimized landing page in acts 815, 820, 835 and 840 may further include creating a web page in HTML or any other format. The web page may include business information or keywords associated with the business information. For example, any one of acts 815, 820, 835 and 840 may further include generating an HTML tag and inserting a keyword in the HTML tag, wherein the keyword may be associated with business information. For example, keywords associated with a business offering may be inserted into a title tag of an HTML page.

Generating a marketing campaign and a mobile-optimized marketing campaign in acts 825 and 845 may further include creating an advertisement including business information or a keyword associated with the business information. For example, the title of an advertisement may include one of a business name, business offering, geographic location, or a keyword associated with a business. In another example, an advertisement may include a map based on geographic information associated with a business. In some embodiments, the advertisement may be geo-targeted to a geographic location served by the business (i.e. targeted for presentation only to consumers who are located in and/or interested in one or more geographic locations). In some embodiments, one or more of acts 825 and 845 may include creating an advertisement by using an algorithm to generate at least one of a title and a body text, and may include creating an advertisement by using a generic body text.

In some embodiments, process 800 may include inserting an analytics tracking code into generated content in any one of acts 815, 820, 825, 835, 840 and 845, thereby allowing a user to track the performance of one or more generated content.

In some embodiments, process 800 may further include an act of hosting content generated by any one of acts 815, 820, 825, 835, 840 and 845, and may include acts of registering a domain name and provisioning a domain name system service to resolve the domain.

Any embodiment disclosed herein may be combined with any other embodiment, and references to “an embodiment,” “some embodiments,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. Such terms as used herein are not necessarily all referring to the same embodiment. Any embodiment may be combined with any other embodiment in any manner consistent with the aspects disclosed herein. References to “or” may be construed as inclusive so that any terms described using “or” may indicate any of a single, more than one, and all of the described terms. Furthermore, it will be appreciated that the systems and methods disclosed herein are not limited to any particular application or field, but will be applicable to any endeavor wherein a value is apportioned among several placements.

Where technical features in the drawings, detailed description, or any claim are followed by references signs, the reference signs have been included for the sole purpose of increasing the intelligibility of the drawings, detailed description, and claims. Accordingly, neither the reference signs nor their absence are intended to have any limiting effect on the scope of any claim placements.

Having now described some illustrative aspects of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention.

What is claimed is:

1. A computer-based method for generating a web presence, the method comprising acts of:
accessing, over a computer network, business information;
generating at least one web presence based on the business information;
generating at least one mobile-optimized web presence based on the business information, the at least one mobile-optimized web presence being generated independently from the at least one web presence;
generating at least one landing page based on the business information;
generating at least one mobile-optimized landing page based on the business information, the at least one mobile-optimized landing page being generated independently from the at least one landing page;
generating at least one marketing campaign based on the business information;
generating at least one mobile-optimized marketing campaign based on the business information;
associating the at least one marketing campaign with the at least one web presence and the at least one landing page; and
associating the at least one mobile-optimized marketing campaign with the mobile-optimized web presence and the at least one mobile-optimized landing page.

2. The method of claim 1, further comprising an act of:
activating the at least one web presence, the at least one mobile-optimized web presence, the at least one landing page, the at least one mobile-optimized landing page, the at least one marketing campaign, and the at least one mobile-optimized marketing campaign.

3. The method of claim 1, wherein accessing business information further includes providing a user interface configured to receive the business information from a user.

4. The method of claim 1, where the mobile-optimized web presence includes at least one of a website, a search engine local places listing, a directory listing, an Internet Yellow Pages listing, a data provider listing, a mapping service listing, a social networking profile page, a microblogging profile page, and a social pinning profile page.

5. The method of claim 1, where the mobile-optimized marketing campaign includes at least one of a video campaign, a paid search campaign, a display advertising campaign, a paid microblogging message campaign, a coupon promotion campaign, a group purchasing promotion campaign, and a remarketing campaign.

6. The method of claim 1, where the mobile-optimized marketing campaign includes a social media campaign.

7. The method of claim 6, where the social media campaign includes at least one of a social sharing campaign, a social pinning campaign, a social voting campaign, a social contest campaign, a social follow campaign, a social like campaign, and a social survey campaign.

8. The method of claim 1, further including acts of:
determining at least one of a height, a width and an orientation of a mobile device; and
formatting the at least one mobile-optimized web presence in response to the determining act.

9. The method of claim 1, further including acts of:
determining at least one of a height, a width and an orientation of a mobile device; and
formatting the at least one mobile-optimized landing page in response to the determining act.

10. The method of claim 1, further including acts of:
determining at least one of a height, a width and an orientation of a mobile device; and
formatting the at least one mobile-optimized marketing campaign in response to the determining act.

11. The method of claim 1, wherein the business information includes business category information.

12. The method of claim 1, wherein the business information includes at least one of business name information, brand name information, and trademark information.

13. The method of claim 12, wherein the act of generating at least one marketing campaign further includes an act of creating an advertisement including a title containing the at least one of business name information, brand name information, and trademark information.

14. The method of claim 12, wherein the act of generating at least one mobile-optimized marketing campaign further includes an act of creating an advertisement including a title containing the at least one of business name information, brand name information, and trademark information.

15. The method of claim 1, wherein the business information includes a business offering.

16. The method of claim 15, wherein the act of generating at least one marketing campaign further includes an act of creating an advertisement including a title containing the business offering.

17. The method of claim 15, wherein the act of generating at least one mobile-optimized marketing campaign further includes an act of creating an advertisement including a title containing the business offering.

18. The method of claim 15, wherein the act of generating at least one landing page further includes an act of looking up a keyword associated with the business offering.

19. The method of claim 15, wherein the act of generating at least one mobile-optimized landing page further includes an act of looking up a keyword associated with the business offering.

20. The method of claim 15, wherein the act of generating at least one marketing campaign further includes an act of looking up a keyword associated with the business offering.

21. The method of claim 15, wherein the act of generating at least one mobile-optimized marketing campaign further includes an act of looking up a keyword associated with the business offering.

22. The method of claim 1, wherein the business information includes geographic information.

23. The method of claim 22, wherein the act of generating at least one web presence further includes an act of creating an HTML web page including a geographic location based on the geographic information.

24. The method of claim 22, wherein the act of generating at least one marketing campaign further includes an act of creating an advertisement including a title containing a geographic location based on the geographic information.

25. The method of claim 22, wherein the act of generating at least one marketing campaign further includes an act of creating an advertisement that is geo-targeted based on the geographic information.

26. The method of claim 25, wherein the act of generating at least one marketing campaign further includes an act of displaying a map based on the geographic information.

27. The method of claim 22, wherein the act of generating at least one mobile-optimized marketing campaign further includes an act of creating an advertisement including a title containing a geographic location based on the geographic information.

28. The method of claim 1, wherein the business information includes hours of operation.

29. The method of claim 28, wherein the act of generating at least one mobile-optimized web presence further includes an act of displaying the hours of operation.

30. The method of claim 28, wherein the act of generating at least one mobile-optimized marketing campaign further includes an act of displaying the hours of operation.

31. The method of claim 1, wherein the act of generating at least one marketing campaign further includes an act of creating an advertisement including a formula-built title.

32. The method of claim 1, wherein the act of generating at least one mobile-optimized marketing campaign further includes an act of creating an advertisement including a formula-built title.

33. The method of claim 1, wherein the act of generating at least one marketing campaign further includes an act of creating an advertisement including a formula-built body text.

34. The method of claim 1, wherein the act of generating at least one mobile-optimized marketing campaign further includes an act of creating an advertisement including a formula-built body text.

35. The method of claim 1, wherein the act of generating at least one marketing campaign further includes an act of creating an advertisement including a generic body text.

36. The method of claim 1, wherein the act of generating at least one mobile-optimized marketing campaign further includes an act of creating an advertisement including a generic body text.

37. The method of claim 1, wherein the at least one web presence, the at least one mobile-optimized web presence, the at least one landing page and the at least one mobile-optimized landing page are all located on a same domain.

38. The method of claim 1, wherein the at least one web presence, the at least one mobile-optimized web presence, the at least one landing page and the at least one mobile-optimized landing page are all located on a same subdomain.

39. The method of claim 1, further comprising an act of hosting at least one of the at least one web presence, the at least one web presence, the at least one mobile-optimized web presence, the at least one landing page and the at least one mobile-optimized landing page on a domain.

40. The method of claim 39, further comprising an act of provisioning a domain name system service to resolve the domain.

41. The method of claim 39, further comprising an act of obtaining the domain.

42. The method of claim 1, wherein the act of generating a web presence further includes an act of applying at least one search engine optimization technique to the web presence.

43. The method of claim 42, the web presence including an HTML tag and the business information including a business offering, the method further including:
looking up a keyword associated with the business offering; and
wherein the act of applying at least one search engine optimization technique to the web presence further includes inserting the keyword in the HTML tag.

44. The method of claim 43 where the HTML tag is a title tag.

45. The method of claim 42, wherein applying at least one search engine optimization technique includes at least one of optimizing keyword density on the web presence, optimizing an HTML meta tag and obtaining external links to the web presence.

46. The method of claim 1, wherein the act of generating a mobile-optimized web presence further includes an act of applying at least one search engine optimization technique to the mobile-optimized web presence.

47. The method of claim 46, the mobile-optimized web presence including an HTML tag and the business information including a business offering, the method further including:
looking up a keyword associated with the business offering; and
wherein the act of applying at least one search engine optimization technique to the mobile-optimized web presence further includes inserting the keyword into the HTML tag of the mobile-optimized web presence.

48. The method of claim 47 wherein the HTML tag is a title tag.

49. The method of claim 1, further including an act of adding an analytics tracking code to at least one of the at least one web presence, the at least one mobile-optimized web presence, the at least one landing page, the at least one mobile-optimized landing page, the at least one marketing campaign and the at least one mobile-optimized marketing campaign.

50. A system comprising:
a memory configured to store business information; and
a processing unit operative to:
access the business information;
generate at least one web presence based on the business information;
generate at least one mobile-optimized web presence based on the business information, the at least one mobile-optimized web presence being generated independently from the at least one web presence;
generate at least one landing page based on the business information;
generate at least one mobile-optimized landing page based on the business information, the at least one mobile-optimized landing page being generated independently from the at least one landing page;
generate at least one marketing campaign based on the business information;
generate at least one mobile-optimized marketing campaign based on the business information;
associate the at least one marketing campaign with the at least one web presence and the at least one landing page; and
associate the at least one mobile-optimized marketing campaign with the mobile-optimized web presence and the at least one mobile-optimized landing page.

51. A computer-readable medium comprising computer-executable instructions that, when executed on a processor of a computer, perform a method for generating a web presence, comprising acts of:
accessing, over a computer network, business information;
generating at least one web presence based on the business information;
generating at least one mobile-optimized web presence based on the business information, the at least one mobile-optimized web presence being generated independently from the at least one web presence;
generating at least one landing page based on the business information;
generating at least one mobile-optimized landing page based on the business information, the at least one mobile-optimized landing page being generated independently from the at least one landing page;
generating at least one marketing campaign based on the business information;
generating at least one mobile-optimized marketing campaign based on the business information;
associating the at least one marketing campaign with the at least one web presence and the at least one landing page; and
associating the at least one mobile-optimized marketing campaign with the mobile-optimized web presence and the at least one mobile-optimized landing page.
